(19) United States
(12) Patent Application Publication
(10) Pub. No.: US 2010/0266322 A1
(43) Pub. Date: Oct. 21, 2010

(54) APPARATUS AND METHOD FOR DESTROYING CONFIDENTIAL MEDICAL INFORMATION ON LABELS FOR MEDICINES

(76) Inventor: Timothy Croskey, Florissant, MO (US)

Correspondence Address: Polster, Lieder, Woodruff & Lucchesi, L.C., 12412 Powerscourt Dr. Suite 200, St. Louis, MO, 63131-3615, US

(21) Appl. No.: 12/425,931

(22) Filed: Apr. 17, 2009

(51) Int. Cl. B41J 2/315

(52) U.S. Cl. 400/120.18

(57) ABSTRACT

An apparatus and method for destroying confidential or other indicia or information on a thermally responsive label. The apparatus comprises a casing having a base layer sized and shaped to be in heat transfer relation with the thermally responsive label. The base layer has a microwave layer configured to receive microwave energy and in response thereto to heat the label to a temperature to activate the thermally responsive material of the label to destroy or obliterate the indicia printed on the label.

### CROSS-REFERENCE TO RELATED APPLICATIONS

Not Applicable

### STATEMENT REGARDING FEDERALLY SPONSORED RESEARCH

Not Applicable.

### BACKGROUND OF THE DISCLOSURE

The present disclosure relates to an apparatus for destroying printed information; and, in particular, relates to a portable apparatus that thermally destroys confidential medical information using microwave or other high energy absorption.

Typically, when a patient visits a physician, the physician writes a prescription or order for the patient. When the pharmacist renews the prescription, the pharmacist locates the pharmaceutical from the pharmacy's inventory that corresponds to the prescription and prepares the pharmaceutical for dispensing to the patient. Often, the pharmaceutical requires a container, such as a pill bottle or other container. Other pharmaceuticals are dispensed in prepackaged or preassembled containers or boxes and the like for dispensing. For those liquid pharmaceuticals that require containers of any nature, the pharmacist dispenses the liquid pharmaceutical to the patient in the appropriate

As a part of the dispensing process, the pharmacist prints a label that has relevant confidential information about the written prescription including the patient's name, physician's name, pharmaceutical's name, dosage, and instructions for taking the pharmaceutical. Other information, such as general information about the pharmaceutical and/or the patient, can also be printed on the label for the patient. Once the pharmacist has completed preparing the container, the label is attached to the specifically filled container or to the preassembled package, and provided to the patient.

Documents, such as these prescription labels, financial records and other items, often contain sensitive or confidential information. With passage of ever more stringent privacy obligations, such as patient's rights bills, the Health Insurance Portability and Accountability Act (HIPPA) requirements in the U.S., there is a need to control private information to maintain confidentiality, reduce liability exposure, and prevent careless or inadvertent disclosure of private information. In the case of the prescription label on the medicine container, such as a medicament container or preassembled package, it is typically required that a hospital or care facility safeguard medical information when discarding medicine containers.

With increasing concerns relating to information security, prevention of identity theft, and protection of personal privacy, a variety of techniques have been adopted to preserve the confidentiality of printed information. A known method of safeguarding such medical information involves burning the container and/or the label. Burning the container or label, however, has adverse effects such as pollution and equipment operating and maintenance costs. Another safeguard method involves removing the prescription label from the container and then shredding the label. Such a shredding method generally complies with safeguarding requirements, but is burdensome in terms of time and effort. Additionally, portions of the label tend to stick to the container and thereby may expose the unshredded confidential information.

As to patient's home destruction of private information included on pill bottle and the like, prior techniques, such as shredding of the container or the label, have several drawbacks. First, most patients do not have a suitable shredder capable of shredding a container along with the label affixed thereto. However, even if a patient had such a shredder, the shredder would make noise, would be susceptible to jamming, and it may be possible for a determined party to reassemble the shredded information. In the event that the patient attempts to remove the label from the container, portions of the label may tend to adhere to the container leading to frustrated and repeated attempts by the patient to remove the label. Safeguard techniques relying on burning, convection heating, or heating elements are undesirable in home environments due to safety concerns associated with hot surfaces, fumes, and cleanliness issues in having to deal with ash or other debris.

### SUMMARY

The present disclosure relates to an apparatus and a method for destroying confidential indicia or information on a record, such as a thermally responsive label (e.g., a label on a medical container or bottle that will change upon the application of heat). The apparatus comprises a casing having a base layer sized and shaped so as to substantially surround the label, wherein the base layer has an outer surface and an inner surface. A microwave layer operatively connects to the inner surface of the base layer wherein the microwave layer is sensitive to microwave energy and in response thereto heats the label to a temperature sufficient to activate the thermally responsive materials of the label positioned within the casing to obliterate (make illegible) the confidential indicia.

The method of the present disclosure involves placing a thermally responsive label in heat transfer relation with a microwave layer that is sensitive to microwave energy so as to heat the label to a temperature sufficient to destroy or obliterate the indicia on the label.

Other features of the present disclosure will be in part apparent and in part pointed out hereinafter.

### BRIEF DESCRIPTION OF THE SEVERAL VIEWS OF THE DRAWINGS

In the accompanying drawings which form part of the specification:

FIG. 1 illustrates a front elevational view of a prescription container (or bottle) having a thermally responsive label affixed thereto, the label having confidential information or indicia printed thereon;

FIG. 2 illustrates the label of FIG. 1 removed from the container;

FIG. 3 illustrates a casing of the present disclosure shown in an open position, the casing having a first portion and a second portion with a fold or hinge line therebetween constructed in accordance with and embodying the present disclosure;

FIG. 4 illustrates an exaggerated edge view of the casing of FIG. 3 illustrating a base layer and a microwave layer;

FIG. 5 illustrates an exaggerated edge view of the label of FIGS. 2-4 with the first and second portions being at a right angle and folded along the fold or hinge line shown in FIG. 2 with a label positioned on the first portion of the casing with the second portion of the casing folding over the label and the first portion in an intermediate position;

FIG. 6 illustrates an exaggerated edge view of the label of FIGS. 2-5 with the first and second portions being folded on each other along the fold line in a closed position and with the label disposed between the first and second portions such that upon the microwave layers being activated by microwave energy the heat sensitive label will obliterate the confidential information on the label;

FIG. 7 illustrates a front elevational view of the casing shown in FIG. 6 disposed within a microwave oven for activation of the microwave layers;

FIG. 8 illustrates a front elevational view of the label of FIG. 7 with the confidential information shown as destroyed or obliterated;

FIG. 9 illustrates a front elevational view of a cylindrical prescription container having a thermally responsive label affixed thereto with the label having confidential information thereon prior to being deposited or disposed within a cylindrical casing or sleeve constructed n accordance with and embodying the present disclosure;

FIG. 10 is a view of the casing or sleeve of FIG. 9 having the container disposed therein with the casing positioned within a microwave oven;

FIG. 11 illustrates a front elevational view of the container and label of FIGS. 9 and 10 with the confidential information shown as destroyed or obliterated after heating;

FIG. 12 illustrates a variety different sizes of casings or sleeves of the type shown in FIG. 9 for accommodating containers of different diameters or cross sections;

FIG. 13 illustrates a front elevational view of a prescription container having a thermally responsive label having confidential information printed thereon affixed to the container, and perspective view of a tubular casing or sleeve constructed in accordance with and embodying the present disclosure where the casing is expandable and contractible to accommodate containers of different diameters;

FIG. 14 illustrates an end view of the casing of FIG. 13 illustrating the base layer and microwave layer of the expandable and contractible casing wound on one another to enlarge or contract the central opening in the casing to receive containers of different diameters;

FIG. 15 is an end view of the casing of FIGS. 13 and 14 contracted to receive a smaller diameter container positioned within the central opening of the casing;

FIG. 16 is an end view of the casing of FIGS. 13 and 14 expanded to receive a larger diameter container positioned within the central opening of the casing;

FIG. 17 is a front elevational view of the casing of FIGS. 13-16 having a container received in the central opening of the casing, with the casing and container positioned within a microwave oven; and

FIG. 18 illustrates the container and label of FIG. 17 after the casing has been exposed to microwave energy to heat the label on the container to a temperature sufficient to destroy or obliterate the confidential information on the label affixed to the container.

Corresponding reference numerals indicate corresponding parts throughout the several figures of the drawings.

### DESCRIPTION OF THE PREFERRED EMBODIMENT

The following detailed description illustrates the present apparatus by way of example and not by way of limitation. The description clearly enables one skilled in the art to make and use the tool, describes several embodiments, adaptations, variations, alternatives, and uses of the apparatus, including what is presently believed to be the best mode of carrying out the invention.

The present disclosure relates to an apparatus for destroying confidential information. For purposes of illustrations only, the apparatus will be described as incorporated into destroying medical information printed on a thermally responsive label for a medicament container.

A medicament or pill container 10 used to dispense pharmaceuticals in known manners and in accordance with the principles of the present disclosure is shown in FIG. 1. The medicament container 10 includes a bottle or vessel 12 and a cap 14 for closing the bottle. The bottle or vessel 12 is shown to be generally cylindrical having a closed end 16 and an open end (not shown) that receives cap 14 for closing the bottle. The cap 14 can be affixed to the mouth of the bottle in any known manner, such as by threading the cap onto the open end of the vessel 12; or any of the known types of child-safety cap configurations; or the cap can be snapped in place on the open end of the container. As noted, bottle 12 is shown to be cylindrical, but containers of any shape may be used in conjunction with the present disclosure.

When a pharmacist prepares the medicament container 10 to dispense a pharmaceutical, the pharmacist follows the instructions found on a prescription or order prepared by a physician. As is well known, the pharmacist selects the prescribed pharmaceutical from an inventory and places the correct number of pills in the bottle or vessel 12 or dispenses the correct amount of pharmaceutical liquid into a suitable vessel 12 and closes the vessel 12 with the cap 14. The pharmacist also prints out a label 18 that is placed on the container 10. Typically, the label 18 contains confidential information such as, but not limited to, the patient's name, the physician's name, the name of the pharmaceutical, the dosage and the instructions. Other confidential or personal information may also be included on the label 18. As seen in FIG. 1, the label 18 is rectangular and fits on the outer surface 28 of the container 10. Different types and shapes of the containers 10 and of the labels 18 are known, such as cylindrical shaped containers and rectangular shaped labels. For example, different shaped containers may have a variety of sizes ranging from heights from about a half inch to about ten inches and an outer surface, width or diameter from about a half inch to about six inches.

Preferably, the label 18 comprises a thermally-responsive record material. Thermally-responsive record materials are known in the art such as that disclosed in U.S. Publication No. U.S. 2005/0282704, which is incorporated in this disclosure in its entirety by reference. This record material comprises a substrate having provided thereon a heat sensitive, color-forming composition. The color-forming composition includes dye material and an electron accepting developer material. The dye material comprises chromogenic materials, such as phthalide, leucauramine and fluoran compounds. The known thermally-responsive record material is susceptible to rapid destruction when exposed to energy absorption or heat above ambient temperature. In particular, the dye and developer material are contained in a coating on a substrate which, when heated to suitable temperature, melt or soften to permit the materials to react, thereby producing a colored mark. Thus, the thermally-responsive material reacts to destroy indicia on the label 18. The label 18 may also comprise a thermally-responsive material that is susceptible to rapid burning when exposed to energy absorption or heat. The term “colored” dye material need not make any color mark other than black.

Turning to FIGS. 3-6, in a first embodiment, the apparatus, generally shown as 20, of the present disclosure comprises a casing or sleeve or housing 22 having a base layer 24 and a microwave activated layer 26. It should be noted that base layer 24 and microwave layer 26 are not drawn to scale in FIGS. 3-6. For clarity's sake, the thicknesses of the layers 24, 26 shown in the figures are exaggerated.

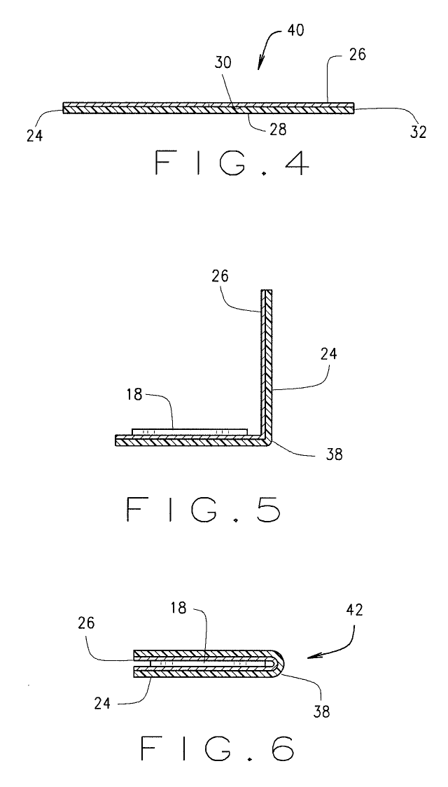

The base layer 24 (FIG. 4) includes an outer surface 28, an inner surface 30, and a sidewall 32 that extends between the outer surface 28 and the inner surface 30 at the edges of the base layer 24. Optimally, the base layer 24 comprises a substrate of a paperboard or corrugated paper and a polyethylene terephthalate (PET) material adhered or coupled to the paperboard. In one example, the paperboard couples to the PET material through the use of a pressure sensitive adhesive. Suitable pressure sensitive adhesives include solvent-coatable, hot-melt-coatable, radiation-curable and water-based emulsion type adhesives that are known in the art. Examples of a pressure sensitive adhesive include silicones, polyolefins, polyurethanes, polyesters, acrylics, epoxies, rubber-resin, and polyamides. The adhesive materials are representative of an embodiment and are not intended to limit the scope of the disclosure.

As shown in FIG. 3, the casing 20 when in its open or flat position is shown to have a first portion 34, a second portion 36, and a fold line or living hinge 38 connecting the first and second portions 34, 36. The first portion 34 and the second portion 36 can be folded relative to one another between their open position (as shown in FIGS. 3 and 4) to a partially folded or intermediated position (as shown in FIG. 5) by folding the first and second portions relative to one another along fold line 38. Further, the casing 20 can be continued to be pivoted to a folded or closed position (as shown in FIG. 6) via the living hinge 38 in which the first and second portions 34, 36 are folded over each other.

In the embodiment of FIGS. 3-6, the base layer 24 is shown to be rectangular. The base layer 24, however, can have a variety of shapes such as elliptical, oval, circular, triangular, square, or other appropriate configuration. Optimally, the sides of the rectangular base layer 24 may have a length ranging from about two inches to about fourteen inches. The dimensions, however, are representative of an embodiment and are not intended to limit the scope of the disclosure and longer or shorter sides can be provided as desired. The base layer 24 can be of any size to accommodate the needs of users, or of the nature of the labels 18 or containers 12 of any size or shape.

The microwave layer 26 comprises a metalized layer operatively connected to the inner surface 30 of the base layer 24. The microwave layer 26 operatively connects to the inner surface 30 of the first and second portions 34, 36. In one example, the microwave layer 26 operatively connects to the inner surface 30 by an adhesive, optimally a high temperature structural epoxy resin adhesive.

In one example of the embodiment of FIGS. 3-6, the microwave layer 26 comprises a microwave susceptor. Microware susceptors are devices which, when exposed to microwave energy, are heated by the microwave energy. In particular, microwave susceptors are typically a metallic film or the like that is responsive to microwave energy to heat the foil and a substance (e.g., label 18) in heat transfer relation to the susceptor to convert microwave energy into exothermic thermal energy to produce heat. Thus, microwave susceptors convert a portion of incident microwave energy into heat. By placing the microwave susceptor next to a product in a microwave oven, the surface of the product exposed to the microwave susceptor is surface-heated by the susceptor.

In particular, when the microwave susceptor is placed in a microwave oven and exposed to microwave energy, current begins to flow in the microwave susceptor due to an electric field generated by the microwave oven. The microwave susceptor maintains its electrical continuity throughout exposure to microwave energy. This electrical continuity allows continued absorption of microwave energy by the microwave susceptor. As the current flows, the microwave susceptor begins to heat as a function of the current generated and the surface resistance of the microwave susceptor. The adhesive connecting the microwave layer 26 to the inner surface 30 is capable of preventing large impedance shifts of the microwave susceptor by strong bonding of the microwave susceptor.

The microwave susceptor preferably comprises a metal or metal alloy film, such as aluminum, stainless steel, nickel/iron/molybdenum alloys or nickel/iron/copper alloys. For a metal or metal alloy as the microwave susceptor, the coating thickness may be from about 20 to 500 Angstroms, preferably from about 50 to 70 Angstroms.

The microwave susceptor may be constructed by a variety of methods such as vacuum metallization of conductive particles dispersed onto a suitable binder. The microwave susceptor may be applied as the microwave layer 26 by vapor coating or alternatively by coating a solution of metal particles dispersed in a solvent over the inner surface 30 of the base layer 24.

In one example, the metal of the microwave susceptor may be vaporized as a mixture of ions and charged metallic droplets of small size and size distribution. The vaporized metal is manipulated with electric fields and focused on the inner surface 30 of the base layer 24. The process is continued until the desired thickness of the layer is obtained. Other processes known in the art can be used to deposit a metallic layer on the microwave layer 26, such as electroless, electrolytic deposition or vacuum metallization methods.

In another example of the embodiment of FIGS. 3-6, the microwave layer 26 comprises a microwave shield. Microwave shields are devices that do not heat appreciably in response to microwave energy, but reflect virtually all incident microwaves. Metallic foils are generally employed as microwave shields. Microwave shielding materials include relatively thick substrates of electrically conductive metals such as aluminum foil that reflect microwave energy without appreciably generating thermal energy. The microwave shield may be adhesive laminated to the inner surface 30. The degree of shielding can be reduced by perforations or by dividing the foils. Alternatively, metal mesh, grids or perforations in the metal or metal foil, having apertures or openings greater than about 2 mm in diameter, will provide partial shielding.

As described, microwave layer 26 may be selected such that the resulting microwave layer 26 is a susceptor, or a shield. The thickness of the microwave layer 26 layer may determine whether the resulting layer is a susceptor or a shield. Typically, a metallic layer having a thickness greater than 1 micrometer will essentially reflect microwaves, without arcing or appreciable heating, and act as a microwave shield. A metallic layer having a thickness less than 1 micrometer can act as a susceptor.

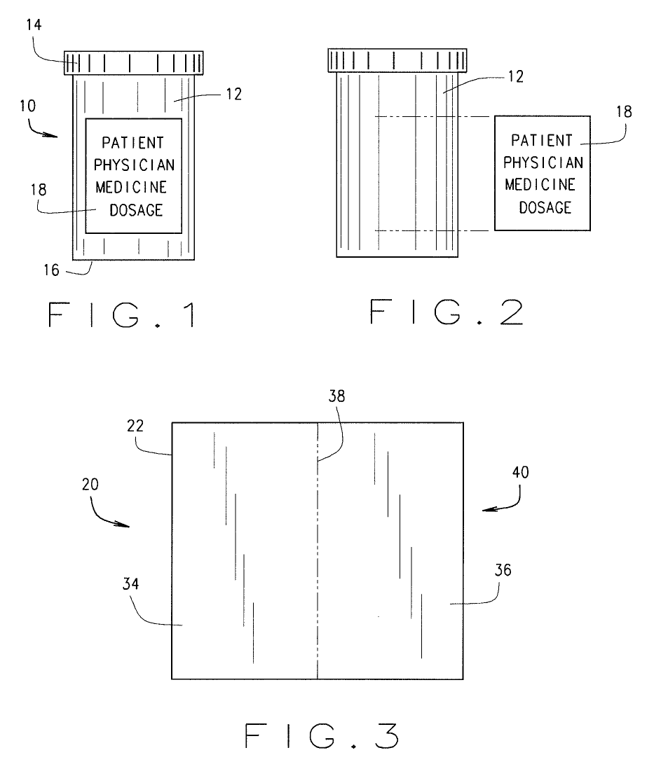

Turning to FIGS. 3-8 and referring to FIGS. 1 and 2, during operation, the user removes the thermally responsive label 18 and associated confidential information printed thereon from the container 10. The user then handles the casing 22 by moving the first portion 34 and the second portion 36 of the base layer 24 to the open position or partially folded position of the casing, as shown in FIGS. 3 and 5. In the open position, casing 22 exposes the microwave layer 26 to the user. The user places the label 18 on the microwave layer 26 connected to the first portion 34, and then folds the second portion 36 through the intermediate position (FIG. 5) to the closed position, as in FIG. 6 to position the microwave layer 26 connected to the second portion 36 in heat transfer relation or in contact with the label 18. In the closed, folded position, the casing 22 substantially surrounds the label 18. With the thermally responsive label 18 positioned within the casing 22, the user places the casing 22 in a microwave oven 43 and activates the microwave oven 43.

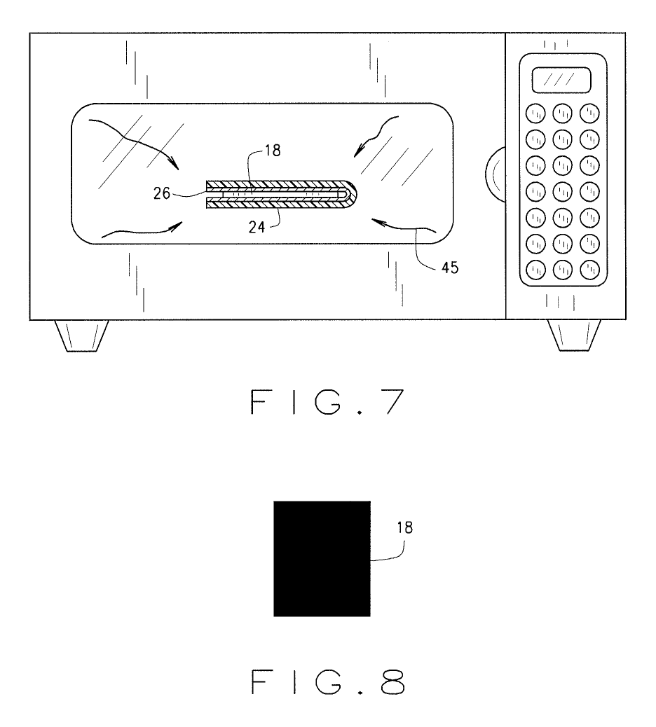

The microwave oven 43 emits microwave energy 45 in the form of microwaves toward the casing 22, wherein the microwave layer 26 receives the microwave energy 45 (FIG. 7). In response thereto, the microwave layer 26 converts the microwave energy 45 into heat. In particular, when microwave layer 26 is placed in the microwave oven 43 and exposed to microwave energy 45, current begins to flow in the metalized material of the microwave layer 26 due to an electric field generated by the microwave oven 43. The metalized material of the microwave layer 26 maintains its electrical continuity throughout exposure to microwave energy 45. This allows continued absorption of microwave energy 45 by the microwave layer 26.

The microwave layer 26 absorbs energy at a desired frequency (typically between about 0.01 to about 300 GHz) very rapidly, in the range of fractions of a second or a few seconds. In one example, the microwave layer 26 heats the thermally responsive label 18 to a temperature sufficient to heat the label 18 to a temperature sufficient to activate dyes in the label to destroy or obliterate the confidential information on the label, as shown in FIG. 8. Higher or lower temperatures and longer or shorter times would be expected depending on the loading in the microwave oven 43, thickness of the microwave layer 26 and the size of the label 18. The frequencies, temperatures and times, however, are representative of an embodiment and are not intended to limit the scope of the disclosure.

As the current flows, metalized layer of the microwave layer 26 begins to heat as a function of the current generated and the surface resistance of the microwave layer 26. The label 18 is surface-heated by the produced heat of the microwave layer 26. In response thereto, the material of the label 18 reacts to the heat and destroys the indicia on the label 18 (FIG. 8). The energy from the microwave layer 26 heats the label 18 to a temperature that activates a thermal reaction of the materials of the label 18, that destroys the indicia printed on the label 18. In another mode of operation, the energy from the microwave layer 26 heats the label 18 to a warm temperature so that the label 18 is burned to destroy the indicia printed on the label 18.

Turning to FIGS. 9-12, a second embodiment of a casing 46 of the present disclosure is shown with medicament or pill container 10 and associated thermally responsive label 18. In this embodiment, the casing 46 is shown to be of a curvilinear or cylindrical tubular shape. The casing 46 comprises an outer base layer 48 and an inner microwave layer 50. The outer base layer 48 and the inner microwave layer 50 form a hollow cylindrical sleeve. The base layer 48 and the microwave layer 50, however, can form other configurations such as, for example, tubular sleeve having a square, rectangular, triangular, or other polygonal or curvilinear cross section. The casing 46 has a length from about one inch to about fourteen inches. The dimensions, however, are representative of an embodiment and are not intended to limit the scope of the disclosure and longer or shorter sizes can be provided as desired. The casing 46 can be of any size to accommodate characterizations of users, or of the nature of documentary labels or containers of any size.

It should be noted that outer base layer 48 and inner microwave layer 50 are not drawn to scale in FIGS. 9, 10 and 12. For clarity's sake, the thicknesses of the layers 48, 50 shown in the figures are exaggerated. The outer base layer 48 may comprise the previously described base materials. The inner microwave layer 50 may also comprise the previously described microwave susceptor. Alternatively, the inner microwave layer 50 may comprise the previously described microwave shield.

In the illustrated embodiment of FIGS. 9 and 12, the casing 46 may be provided in a variety of different diameters and lengths where base layer 48 includes an outer circular wall 52 and an inner circular wall 54. The inner microwave layer 50 operatively connects to the inner circular wall 54 and defines a receptacle or passageway 56 in the casing 46. Passageway 56 is shown to be cylindrical having an opening 58 and another opening 60 at ends of the microwave layer 50. The passageway 56 is shown to have a generally circular smooth cross-sectional configuration along the length of the passageway 56. To match the diameters of containers 10, the passageway 56 can have other cross sections, depending on the cross section of the containers configurations such as, for example, tubular with a square, rectangular, triangular, pentagonal, hexagonal or octagonal cross section.

For the embodiment of FIG. 9, the container receiving passageway or receptacle 56 has a diameter from about a half of an inch to about six inches. Further, the passageway 56 has a length from about one inch to about fourteen inches. The dimensions, however, are representative of an embodiment and are not intended to limit the scope of the disclosure. The passageway 56 can be of any size to accommodate characterizations of users, or the nature of documentary labels and/or containers of any size.

FIG. 12 shows casings 46a, 46b and 46c of three different sizes (i.e., of different cross sections and lengths). The casings 46a, 46b and 46c provide a plurality of different sized passageways 56a, 56b and 56c formed by the respective microwave layer 50. These passageways 56a, 56b and 56c correlate to different sized medical containers 10. The casings 46a, 46b and 46c may be connected to each other as a single portable piece via connectors such as, but not limited to, adhesives, hook and loop fasteners and welds. Alternatively, the casings 46a, 46b and 46c may be separate from each other providing individual, portable and different sized passageways 56a, 56b and 56c. In one example, separate casings 46a, 46b and 46c may nest within one another for convenient storage (not shown). Regardless of the connectivity, casings 46a, 46b and 46c allow the user the convenience of choosing the preferred sized passageway 56a, 56b and 56c for a particularly sized container 10.

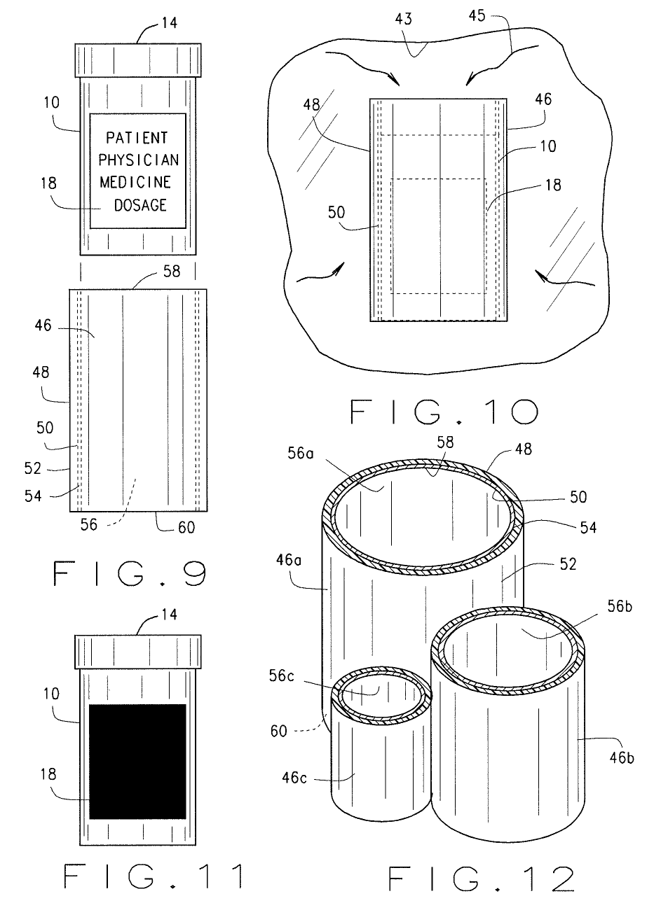

For the second embodiment of FIGS. 9-12, during operation, the user deposits the container 10 with its thermally responsive label 18 affixed thereto within the passageway 56 of the casing 46. The user places the casing 46 in the microwave oven 43 and activates the microwave oven 43 (FIG. 10). In the embodiment when the microwave layer 50 comprises the microwave susceptor, the label 18, that is located with the casing 46, optimally contacts (or is otherwise in heat transfer relation with) the microwave susceptor such that the microwave layer 50 heats the thermally responsive label 18 to a temperature sufficient to destroy or obliterate the confidential information on the label when the microwave layer 50 receives the emitted microwave energy 45 from the microwave oven 43, as previously described.

In another use of the casings 46a, 46b and 46c of FIG. 12, the microwave layer 50 comprises the microwave shield. In this method of operation, the microwave layer 50 is separated and spaced from the thermally responsive label 18. In other words, the diameter of the passageway 56 is larger than the outer diameter or outer surface of the container 10. The user deposits the container 10 within the passageway 56 of the casing 46, wherein the container 10 or label 18 does not contact the microwave layer 50. During operation of the microwave oven 43, the microwave shield reflects the incident microwaves 45, generated by the microwave oven 43, toward the thermally responsive label 18. In response to the reflected microwave energy 45, the thermally responsive materials of the label 18 react and destroy the indicia printed on the label 18. The reflected microwave energy 45 heats the label 18 to a temperature that activates a thermal reaction of the materials that destroys the indicia printed on the label 18. In another mode of operation, the energy from the microwave layer 50 heats the label 18 to a temperature so that the label 18 is burned to destroy the indicia printed on the label 18.

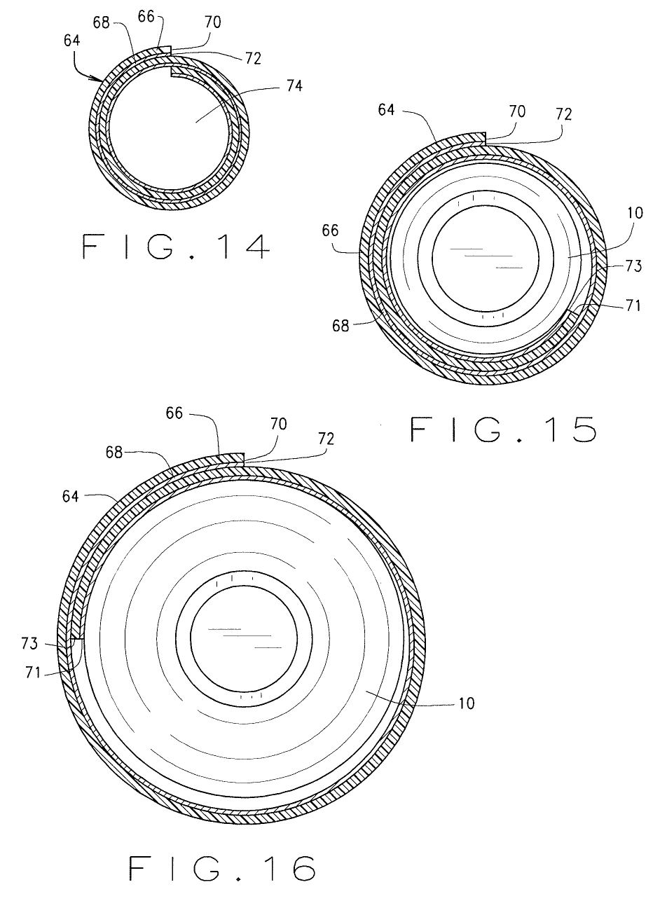

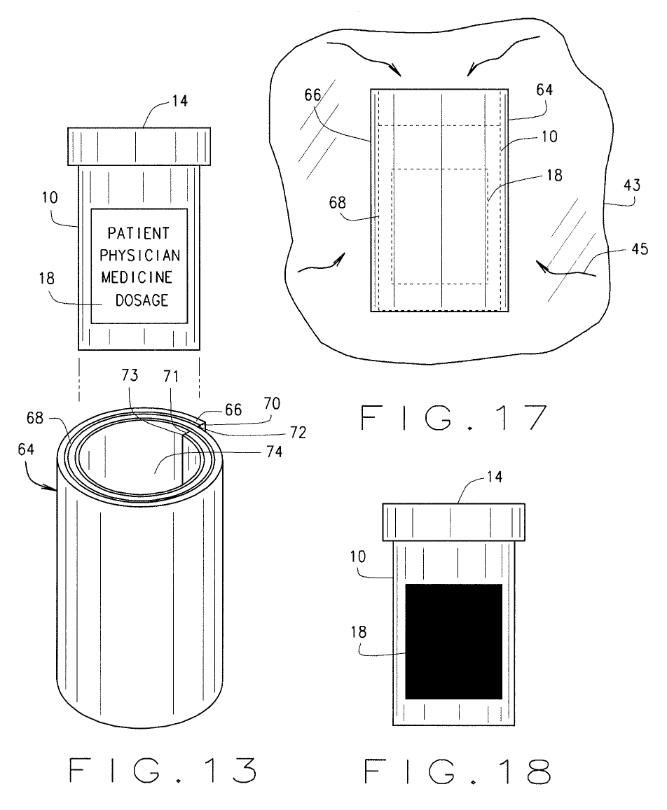

Referring to FIGS. 13-18, a third embodiment of a casing 64 of the present disclosure is shown. The casing 64 comprises a base layer 66 and a microwave layer 68 (FIG. 13). The casing 64 can have a length from about one inch to about fourteen inches. The base layer 66 and the microwave layer 68 are configured to form a flexible configuration such as a coil or spiral configuration (FIGS. 13-17), where the ends of casing 64 are not joined, but are free to expand or contract so as to form a central opening of different sizes (diameters) so as to accommodate containers of different diameters. It should be noted that thicknesses of base layer 66 and microwave layer 68 are not drawn to scale in FIGS. 13-17. For clarity's sake, the thicknesses of the layers 66, 68 shown in the figures are exaggerated. The base layer 66 may comprise the previously described base materials. The microwave layer 68 may comprise the previously described microwave susceptor. Alternatively, the microwave layer 68 may comprise the previously described microwave shield.

FIGS. 14, 15 and 16 show a casing 64 of the same length. The casing 64 is shown in a contracted position so as to enclose a smaller container 10 in FIG. 15. In FIG. 16, the casing 64 is shown in an expanded condition so as to enclose a larger container of greater diameter. In this manner, a single casing 64 may be used with a wide range of container diameters.

In this third embodiment, the base layer 66 has a first end 70 and second end 71. The microwave layer 68 has a first end 72 and a second end 73. End 72 and 73 are shown to be coextensive, respectively, with ends 70 and 71 of layer 66, as seen in FIG. 14. The layers 66 and 68 can have lengths from about two inches to about 14 inches. The base layer and microwave layer 68 comprise spring-like, or flexible materials. The inside of the microwave layer 68 can slide along the outside of base layer 66 as the casing 64 expands and contracts to accommodate different size containers. The materials of the base layer 66 and microwave layer 68 are such that once they are moved to a certain position, such as what are shown in FIG. 15, or in FIG. 16, the prehensile forces of layers 66 and 68 will cause the inside surface of layer 68 to grip against container. As can be seen in FIGS. 13-14, in the coiled configuration, microwave layer 68 forms a receptacle or passageway passageway 74 through the casing 64 which passageway 74 can be expanded and contracted among a plurality of sizes. Preferably, the diameter of the passageway 74 can expand and contract between about one-half of an inch to about 14 inches.

The flexible materials of the base layer 66 and the microwave layer 68, cause layers 66 and 68 to apply a prehensile gripping force against the container 10 to hold container 10 within the passageway 74. Since the casing 64 can form the coil configuration, the casing 64 provides the user with the convenience of repeatedly forming the preferred sized passageway 74 for a particularly sized container 10. Accordingly, the user has the convenience of one casing 64 expanding or contracting to accept different sized containers 10.

For the third embodiment of FIGS. 13-17, during operation, the user deposits the container 10 and thermally responsive thermally responsive label 18 affixed thereto within the passageway 74 of the casing 64. The prehensile force brought about by the flexible materials of the base layer 66 and the microwave layer 68 flex or tension to coil around the container 10 so that the microwave layer 68 contacts the label 18.

The user can place the casing 64 in the microwave oven 43 and activate the microwave oven 43 as previously discussed. In one example, the microwave layer 68 comprises a microwave susceptor. Optimally, the thermally responsive label 18 contacts the microwave susceptor so that the microwave layer 68 heats the label 18 when the microwave layer 68 receives the emitted microwave energy 45 from the microwave oven 43. In response to the surface heat, the materials of the label 18 react and destroy the indicia printed on the label 18. The energy from the microwave layer 68 heats label 18 to a temperature that activates a thermal reaction of the materials label 18 that destroys the indicia printed label 18. In another embodiment, the heat generated by the microwave layer 68 reaches a warm temperature so that the label 18 is burned to destroy the indicia printed on the label 18. Upon destroying the indicia, the user removes the container 10 (FIG. 18) from the passageway 74. Upon removal of the container 10, the flexible materials of the base layer 66 and the microwave layer 68 can contract to the predetermined smaller passageway.

As various changes could be made in the above constructions without departing from the scope of the disclosure, it is intended that all matter contained in the above description or shown in the accompanying drawings shall be interpreted as illustrative and not in a limiting sense.

I claim:

1. A microwaveable apparatus for containing a thermally responsive label and for destroying indicia printed on the label when the apparatus is exposed to microwave energy, the apparatus comprising:
a casing having a base layer sized and shaped to be in heat transfer relation with the thermally responsive label, the base layer having an outer surface and an inner surface; and
a microwave layer operatively connected to the inner surface wherein the microwave layer is configured to be in heat transfer relation with the thermally responsive label and is configured to allow the microwave layer to receive microwave energy and in response thereto to heat the label to a temperature to obliterate the indicia printed on the thermally responsive label.

2. The microwaveable apparatus of claim 1 wherein the outer surface and the inner surface of the base layer are segmented to form a first portion, a second portion, and a living hinge connecting the first portion and the second portion, so that the first portion and the second portion are configured to move from an open position through an intermediate position to a closed position via the living hinge.

3. The microwaveable apparatus of claim 2 wherein the microwave layer is operatively connected to the inner surface of the first portion and the second portion.

4. The microwaveable apparatus of claim 3 wherein, in the closed position, the microwave layer connected to the first portion is configured to be in heat transfer relation with a side of the thermally responsive label and the microwave layer connected to the second portion is configured to be in heat transfer relation with another side of the thermally responsive label.

5. The microwaveable apparatus of claim 4 wherein the microwave layer comprises a microwave suspector.

6. The microwaveable apparatus of claim 1 wherein the casing is of generally a tubular shape with the outer surface comprising an outer tubular wall and the inner surface comprising an inner tubular wall.

7. The microwaveable apparatus of claim 6 wherein the microwave layer is sized and shaped to define a receptacle within the casing.

8. The microwaveable apparatus of claim 7 wherein the receptacle is sized and shaped to accept and to surround the thermally responsive label.

9. The microwaveable apparatus of claim 8 wherein the microwave layer is in heat transfer relation with the thermally responsive label.

10. The microwaveable apparatus of claim 9 wherein the microwave layer comprises a microwave suspector.

11. The microwaveable apparatus of claim 8 wherein the microwave layer is configured to be spaced in a position free from contacting the thermally responsive label when the receptacle surrounds the thermally responsive label.

12. The microwaveable apparatus of claim 11 wherein the microwave layer comprises a microwave shield.

13. The microwaveable apparatus of claim 7 wherein the base layer and the microwave layer have a combined first end and second end and the base layer and microwave layer comprise flexible materials such that the first end is configured to wind about the second end.

14. The microwaveable apparatus of claim 13 wherein the base layer and the microwave layer are configured to expand and to contract the passageway among a plurality of sizes.

15. A microwaveable apparatus for containing a thermally responsive label and for destroying indicia printed on the thermally responsive label when the apparatus is exposed to microwave energy, the apparatus comprising:
a casing having a base layer sized and shaped to substantially surround the thermally responsive label, the base layer includes a first portion, a second portion and a living hinge connecting the first portion and the second portion, the first portion and the second portion being configured to move from an open position, through an intermediate position to a folded, closed position via the living hinge; and
a microwave layer operatively connected to the first portion and to the second portion such that in the folded position the microwave layer connected to the first portion is configured to be in heat transfer relation with a side of the thermally responsive label and the microwave layer connected to the second portion is configured to be in heat transfer relation with another side of the thermally responsive label, so that the microwave layer is configured to receive microwave energy and in response thereto heats the label to a temperature to activate the thermally responsive material of the label to obliterate the indicia printed on the thermally responsive label.

16. The microwaveable apparatus of claim 15 wherein the microwave layer comprises a microwave suspector.

17. A microwaveable apparatus for containing a container having a thermally responsive label affixed thereto and for destroying indicia printed on the thermally responsive label when the apparatus is exposed to microwave energy, the apparatus comprising:
a tubular casing having a base layer comprising an outer curvilinear wall and an inner curvilinear wall; and
a microwave layer operatively connected to the inner wall, the microwave layer being sized and shaped to form a receptacle within for receiving the label affixed to a container, the casing being configured to receive microwave energy and in response thereto to heat the label to a temperature to activate the thermally responsive material of the label to obliterate the indicia.

18. The microwaveable apparatus of claim 17 wherein the microwave layer comprises a microwave suspector.

19. The microwaveable apparatus of claim 17 wherein the microwave layer comprises a microwave shield.

20. A method of destroying indicia printed on a thermally responsive label, the method comprising:
providing a casing having a first portion, a second portion and a living hinge connecting the first portion and the second portion and having a microwave layer connected to the first portion and the second portion;
opening the casing by moving the first portion away from the second portion via the living hinge;
placing the thermally responsive label on the microwave layer;
closing the casing by moving the second portion through an intermediate position to a closed position over the first portion such that the microwave layer connected to the second portion contacts the thermally responsive label;
placing the casing in a microwave oven; and
activating the microwave oven so that the microwave layer receives microwaves generated by the microwave oven and in response thereto heats the label to a temperature to activate the thermally responsive material of the label to obliterate the indicia.

21. A method for destroying indicia printed on a thermally responsive label affixed to a container, the method comprising:
providing a tubular casing comprising an outer tubular wall and an inner tubular wall and having a microwave layer operatively connected to the inner tubular wall, the microwave layer being sized and shaped to form a receptacle within the casing;
placing the container with the label affixed thereto within the receptacle;
placing the casing with the container therein in a microwave oven; and
activating the microwave oven so that the microwave layer receives microwave energy and in response thereto heats the label to a temperature to activate the thermally responsive material of the label to obliterate the indicia.
